(19) United States
(12) Patent Application Publication
(10) Pub. No.: US 2015/0188379 A1
(43) Pub. Date: Jul. 2, 2015

(54) INSULATING UNIT FOR DRIVING MOTOR

(71) Applicant: HYUNDAI MOTOR COMPANY, Seoul (KR)

(72) Inventors: Myung Kyu JUNG, Seoul (KR); Young Jin SEO, Yongin-si (KR); Dong Yeon HAN, Seoul (KR)

(21) Appl. No.: 14/520,786

(22) Filed: Oct. 22, 2014

(30) Foreign Application Priority Data
Dec. 31, 2013 (KR) 10-2013-0168644

(51) Int. Cl. H02K 3/34

(52) U.S. Cl. CPC H02K 3/34

(57) ABSTRACT

An insulating unit for a driving motor which insulates between at least three coils inserted into slots of a stator and between the coils and a stator core may include a first main insulating surface configured to correspond to one inside surface of a slot in a length direction of the slot. A second main insulating surface is connected to one end of the first main insulating surface, encloses two coils among the at least three coils, and corresponds to a portion of another inside of the slot. A third main insulating surface is connected to the other end of the first main insulating surface, encloses at least one of remaining coils, and corresponds to the remaining portion of the other inside of the slot. A first sub insulating surface is connected to the second main insulating surface, encloses one of the two coils.

### CROSS-REFERENCE TO RELATED APPLICATION

This application claims the benefit of priority to Korean Patent Application No. 10-2013-0168644 filed in the Korean Intellectual Property Office on Dec. 31, 2013, the entire contents of which are incorporated herein by reference.

### TECHNICAL FIELD

The present disclosure relates to a driving motor for an environmentally-friendly vehicle, and more particularly, to an insulating unit for a driving motor to ensure insulation between coils and a core of a stator and between the coils

### BACKGROUND

Generally, a hybrid vehicle or an electric vehicle which is called an environmentally-friendly vehicle runs by an electric motor (hereinafter, referred to as “driving motor”) which obtains a torque by electrical energy.

The hybrid vehicle is driven in an electric vehicle (EV) mode which is a pure electric vehicle mode using only power of the driving motor or is driven in a hybrid electric vehicle (HEV) mode using both torques of an engine and the driving motor as power. A general electric vehicle is driven using the torque of the driving motor as power.

For example, the driving motor which is used as a power source of the environmentally-friendly vehicle mainly uses a permanent magnet synchronous motor (PMSM).

As such, the driving motor as the permanent magnet synchronous motor which is used as the power source of the environmentally-friendly vehicle includes a stator which generates a magnetic flux, a rotor which is disposed at a predetermined air gap from the stator and performs a rotational motion, and a permanent magnet mounted in the rotor.

In this case, the stator has a plurality of slots formed at an inner circumferential side of a stator core, in which an inside of the slot is wound with a stator coil. AC current is applied to the stator coil, and thus, the stator generates a rotating magnetic field which may generate a rotating torque to the rotor.

The driving motor may be classified into a distributed winding type driving motor and a concentrated winding type driving motor depending on a winding scheme of the coil. Among those, the stator of the distributed winding type driving motor may be classified into a segment coil stator and a distributed winding coil stator depending on the winding scheme of the coil.

In the segment coil stator, a coil is primarily molded to have a predetermined shape in advance and inserted into a slot of a stator core, and in the distributed winding coil stator, a coil assembly is inserted into a slot of a stator core.

The segment coil stator may generally have a structure in which 2n (n is an integer) segment coils are inserted into one slot. The segment coil stator needs an insulating part as an insulator to ensure insulation between the coils and the stator core and between the coils in a process of inserting the coils into the slot

The insulating part may be an insulating paper made of a flexible material, in which the insulating paper is molded in, for example, an “S” shape or a “B” shape, and ensures insulation in a scheme to enclose each pair of coils, in which the pair is formed of two coils.

Further, those skilled in the art are pouring their efforts for research and development for improving an insulating structure of the insulating paper to reduce the consumption and cost of the insulating paper and improve the workability and productivity of the stator coil winding.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide an insulating unit for a driving motor capable of saving consumption and cost of an insulating paper to ensure insulation between coils and a core and between the coils in slots of the stator core and improving workability and productivity of a stator coil winding.

According to an exemplary embodiment of the present inventive concept, an insulating unit for a driving motor which insulates between at least three coils inserted into slots of a stator and between the coils and a stator core includes a first main insulating surface corresponding to one inside surface of a slot in a length direction of the slot. A second main insulating surface is connected to one end of the first main insulating surface, encloses the two coils, and corresponds to a portion of another inside of the slot. A third main insulating surface is connected to the other end of the first main insulating surface, encloses at least one of remaining coils, and corresponds to the remaining portion of the other inside of the slot. A first sub insulating surface is connected to the second main insulating surface, encloses one of the two coils which is adjacent to the at least one of remaining coils.

A sheet of insulating paper mounted in the slot may insulate between the at least three coils and between the coils and the stator core.

Two sheets of insulating papers mounted in the slot may insulate between the coils and between the coils and the stator core.

The first sub insulating surface may enclose one of the two coils adjacent to the remaining coil of the two coils between the first main insulating surface.

The insulating unit for a driving unit may further include a second sub insulating surface connected to the third main insulating surface and disposed between the two coils and the at least one of remaining coils adjacent to the two coils.

The second sub insulating surface may be disposed between the first main insulating surface and the third main insulating surface.

The second sub insulating surface may enclose the at least one of remaining coils adjacent to the two coils between the first main insulating surface and the third main insulating surface, and may be disposed between the enclosed coil and the one of the two coils which is adjacent to the enclosed coil.

The first and second sub insulating surfaces may be disposed to overlap each other between the two coils and the at least one of remaining coils adjacent to the two coils.

The first main insulating surface and at least any one of the first and second sub insulating surfaces may be disposed to overlap each other.

The insulating paper may insulate between the coils having a quadrangular section and between the coils and the stator core.

At least one insulating paper mounted in the slot may insulate between the coils and between the coils and the stator core. The insulating paper may insulate between the coils for a>b and between the coils and the stator core when a length of a surface corresponding to a width direction of the slot of the coil is “a,” and a length of a surface corresponding to a length direction of the slot is “b.”

The first, second, and third main insulating surfaces may insulate between the surface corresponding to the length direction of the slot and the core of the stator. The first and second sub insulating surfaces may insulate the surface corresponding to the width direction of the slot between the coils.

The first sub insulating surface may include a first surface insulating a surface corresponding to a width direction of the one of two coils adjacent to the at least one of remaining coils. A second surface is connected to the first surface and disposed between the first main insulating surface and a surface corresponding to a length direction of the adjacent coil. A third surface is connected to the second surface and disposed onto a surface corresponding to the width direction of the two coils.

The second sub insulating surface may include a fourth surface insulating a surface corresponding to the width direction of the at least one of remaining coils adjacent to the two coils.

The second sub insulating surface may include a fourth surface insulating a surface corresponding to the width direction of the at least one of remaining coils adjacent to the two coils. A fifth surface is connected to the fourth surface and disposed between the first main insulating surface and a surface corresponding to a length direction of the at least one of remaining coils. A sixth surface is connected to the fifth surface and disposed between the at least one of remaining coils and a surface corresponding to a width direction of another remaining coil.

According to another exemplary embodiment of the present inventive concept, an insulating unit for a driving motor which has three coils inserted into slots of a stator configured as at least one group and insulates between the coils and a stator core includes a first main insulating surface corresponding to one inside surface of a slot in a length direction of the slot. A second main insulating surface is connected to one end of the first main insulating surface, encloses two coils among the three coils, and corresponds to a portion of another inside of the slot. A third main insulating surface is connected to the other end of the first main insulating surface, encloses the remaining coil, and corresponds to the remaining portion of the other inside of the slot. A first sub insulating surface is connected to the second main insulating surface, encloses one of the two coils which is adjacent to the remaining coil.

The insulating unit for a driving unit may further include a second sub insulating surface connected to the third main insulating surface and disposed between the two coils and the remaining coil adjacent to the two coils between the first main insulating surface and the third main insulating surface.

The first and second sub insulating surfaces may be disposed to overlap each other between the two coils and the remaining coil adjacent to the two coils and the first main insulating surface and the first sub insulating surface may be disposed to overlap each other.

According to yet another exemplary embodiment of the present inventive concept, an insulating unit for a driving motor which insulates between four coils inserted into slots of a stator and between the coils and a stator core includes a first main insulating surface corresponding to one inside surface of a slot in a length direction of the slot. A second main insulating surface is connected to one end of the first main insulating surface, encloses two coils among the four coils, and corresponds to a portion of another inside of the slot. A third main insulating surface is connected to the other end of the first main insulating surface, encloses the other two remaining coils, and corresponds to the remaining portion of the other inside of the slot. A first sub insulating surface is connected to the second main insulating surface, encloses one coil of the two coils, and disposed between the enclosed coil and the other coil among the two coils which is adjacent to the enclosed coil. A second sub insulating surface is connected to the third main insulating surface, encloses one of the other two remaining coils which is adjacent to the two coils between the first main insulating surface and the third main insulating surface.

The first and second sub insulating surfaces may be disposed to overlap each other between the two coils and the one of the other two remaining coils which is adjacent to the two coils and the first main insulating surface and the first and second sub insulating surfaces may be disposed to overlap each other.

According to still another exemplary embodiment of the present inventive concept, an insulating unit for a driving motor which insulates between four coils inserted into slots of a stator and between the coils and a stator core includes a first main insulating surface corresponding to one inside surface of a slot in a length direction of the slot A second main insulating surface is connected to one end of the first main insulating surface, encloses three coils among the four coils, and corresponds to a portion of another inside of the slot. A third main insulating surface is connected to the other end of the first main insulating surface, encloses the remaining coil, and corresponds to the remaining portion of the other inside of the slot. A first sub insulating surface is connected to the second main insulating surface. They enclose two coils among the three coils adjacent to the remaining coil.

The insulating unit for a driving unit may further include a second sub insulating surface connected to the third main insulating surface and disposed between the three coils and the remaining coil adjacent to the three coils, between the first main insulating surface and the third main insulating surface.

The first and second sub insulating surfaces may be disposed to overlap each other between the three coils and the remaining coil adjacent to the three coils and the first and second main insulating surfaces and the first sub insulating surface may be each disposed to overlap each other.

According to the exemplary embodiments of the present inventive concept, it is possible to reduce the total consumption of the insulating paper, save the manufacturing cost, reduce the assembling man hour of the stator coil, and improve the workability and productivity of the stator coil winding.

### BRIEF DESCRIPTION OF THE DRAWINGS

The accompanying drawings are referenced to describe exemplary embodiments of the present inventive concept, and therefore, a technical spirit of the present invention is not to be construed to be limited to the accompanying drawings.

FIG. 1 is a partially exploded perspective view of a stator illustrating an insulating unit for a driving motor according to an exemplary embodiment of the present inventive concept.

FIG. 2 is a cross-sectional configuration diagram of the insulating unit for a driving motor according to the exemplary embodiment of the present inventive concept.

FIGS. 3(a), 3(b) and 3(c) are diagrams for describing an action effect of the insulating unit for a driving motor according to the exemplary embodiment of the present inventive concept.

FIG. 4 is a cross-sectional configuration diagram of an insulating unit for a driving motor according to another exemplary embodiment of the present inventive concept.

FIGS. 5(a, 5(b) and 5(c) are diagrams for describing an action effect of the insulating unit for a driving motor according to another exemplary embodiment of the present inventive concept.

FIG. 6 is a cross-sectional configuration diagram of an insulating unit for a driving motor according to another exemplary embodiment of the present inventive concept.

### DETAILED DESCRIPTION OF THE EMBODIMENTS

Hereinafter, the present disclosure will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

In order to clearly describe the present invention, portions that are not connected with the description will be omitted. Like reference numerals designate like elements throughout the specification.

In addition, the size and thickness of each configuration shown in the drawings are arbitrarily shown for understanding and ease of description, but the present invention is not limited thereto and the thickness are exaggerated to clearly express several parts and regions.

Further, dividing names of components in the following detailed description into first, second, and the like is only to divide the components due to the same configuration and therefore the components are not necessarily limited to an order thereof in the following description.

Throughout the specification, unless explicitly described to the contrary, the word “comprise” and variations such as “comprises” or “comprising,” will be understood to imply the inclusion of stated elements but not the exclusion of any other elements.

In addition, terms, such as “ . . . unit,” “ . . . means,” “ . . . part,” “ . . . member,” and the like, which are described in the specification mean units having a comprehensive configuration performing at least one function or operation.

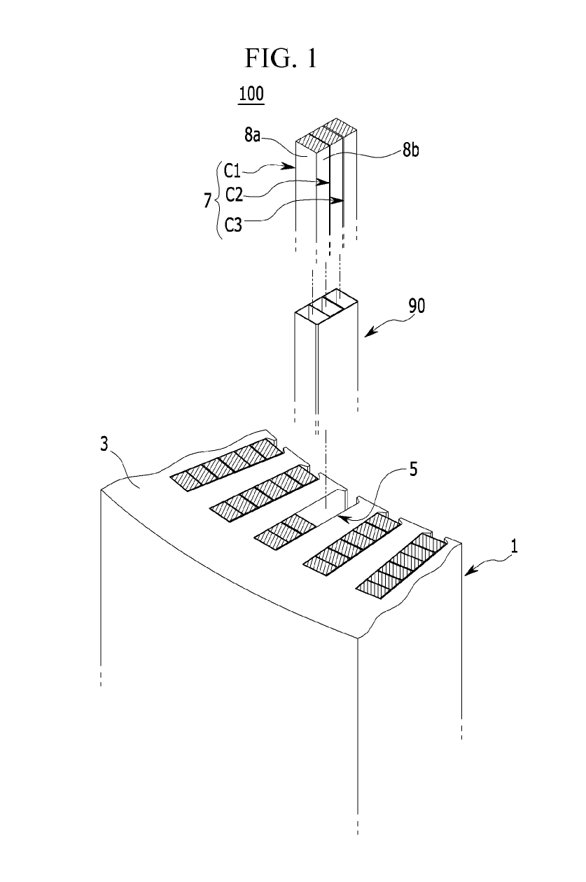

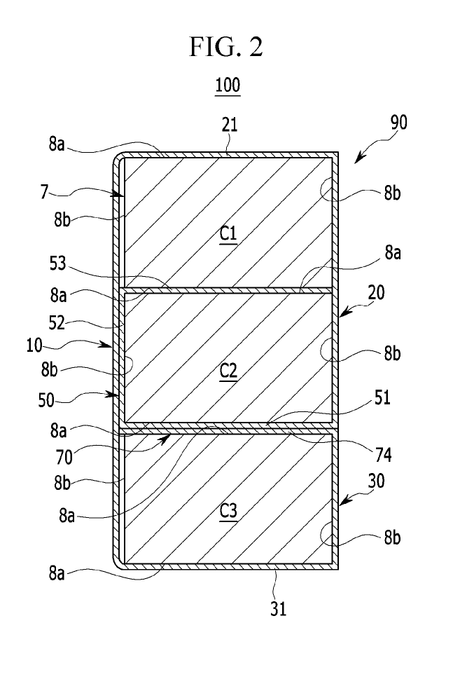

FIG. 1 is a partially exploded perspective view of a stator illustrating an insulating unit for a driving motor according to an exemplary embodiment of the present inventive concept. FIG. 2 is a cross-sectional configuration diagram of the insulating unit for a driving motor according to the exemplary embodiment of the present inventive concept.

Referring to FIGS. 1 and 2, an insulating unit 100 for a driving motor according to an exemplary embodiment of the present inventive concept may be applied to a driving motor for a hybrid vehicle and/or an electric vehicle which may obtain a driving force by electrical energy in an environmentally-friendly vehicle.

For example, the insulating unit 100 for a driving motor according to the exemplary embodiment of the present inventive concept may be applied to a permanent magnet synchronous motor (PMSM) as the driving motor.

Herein, the permanent magnet synchronous motor includes a segment coil stator 1 which generates a magnetic flux, a rotor (not illustrated) which is disposed at a predetermined air gap from the segment coil stator 1 and performs a rotational motion, and a permanent magnet (not illustrated) which is mounted in the rotor.

In this case, the stator 1 includes a stator core 3 in which a plurality of steel plates are stacked, in which the stator core 3 is provided with a plurality slots 5 which directs to a central axis along a circumferential direction and the slot 5 is wound with stator coils 7.

For the insulating unit 100 for a driving motor according to the exemplary embodiment of the present inventive concept, a distributed winding type drive motor may be applied to the segment coil stator 1 in which the stator coils 7 are molded to have a predetermined shape and then inserted into the slot 5 of the stator core 3.

According to the exemplary embodiment of the present inventive concept as described above, the insulating unit 100 for a driving motor is applied to a permanent magnet synchronous motor as a driving motor adopted in an environmentally-friendly vehicle, but it should not be construed that the scope of the present invention is not necessarily limited thereto, and the technical spirit of the present inventive concept may be applied to various kinds and purposes of driving motors.

The insulating unit 100 for a drive motor according to the exemplary embodiment of the present inventive concept is to ensure insulation between the coils 7 and the stator core 3 and between the stator coils 7 in a process of inserting the stator coils 7 into the slots 5 of the segment coil stator 1.

As described above, the stator coil 7 is also called a segment conductor and has a quadrangular cross shape. Hereinafter, a pair of corresponding surfaces which correspond to a width direction of the slots 5 of the stator coils 7 are called first corresponding surfaces 8a, and a pair of corresponding surfaces which correspond to a length direction of the slots 7 are called second corresponding surfaces 8b.

The insulating unit 100 for a driving motor according to the exemplary embodiment of the present inventive concept may include an insulating paper 90 as an insulating part to ensure insulation between the stator coils 7 (hereinafter, simply referred to as ‘coil’) and the stator core 3 and between the coils 7 in the slots 5 of the stator core 3.

The insulating unit 100 for a driving motor according to the exemplary embodiment of the present inventive concept has a structure to reduce the consumption and cost of the insulating paper 90 and improve workability and productivity of a winding of the coils 7.

Therefore, the insulating unit 100 for a driving motor according to the exemplary embodiment of the present inventive concept includes a sheet of insulating paper 90 which is mounted in each slot 5 of the stator core 3 to insulate between the coils 7 and between the coils 7 and the stator core 3.

To this end, the insulating unit 100 for a driving motor according to the exemplary embodiment of the present inventive concept may include the insulating paper 90 which includes a first main insulating surface 10, a second main insulating surface 20, a third main insulating surface 30, a first sub insulating surface 50, and a second sub insulating surface 70.

The insulating paper 90 may be configured of one or two sheets and is mounted in each slot 5 of the stator core 3. The insulating paper 90 may be made of a typical insulating material which may insulate electricity or made of a flexibly changeable material.

According to the exemplary embodiment of the present inventive concept, the first main insulating surface 10 corresponds to the inside surface of the slot 5 and insulates between a second corresponding surface 8b corresponding to a length direction of the slot 5 and the stator core 3.

Hereinafter, the coils 7 are defined by a first coil C1, a second coil C2, and a third coil C3 from the top to the bottom in FIG. 2. Therefore, the first main insulating surface 10 insulates between the second corresponding surface 8b of the first, second, and third coils C1, C2, and C3 and the stator core 3.

According to the exemplary embodiment of the present inventive concept, the second main insulating surface 20 is a surface corresponding to a portion of the inside surface of the slot 5 which faces the opposite inside surface thereof and is connected to one end of the first main insulating surface 10 and simultaneously encloses the first and second coils C1 and C2.

The second main insulating surface 20 insulates between the second corresponding surface 8b of the first and second coils C1 and C2 and the stator core 3. The second main insulating surface 20 may be connected to one end of the first main insulating surface 10 through a first connection surface 21. In this case, the first connection surface 21 may insulate between the first corresponding surface 8a, which corresponds to a width direction of the slot 5, of the first coil C1 and the stator core 3.

According to the exemplary embodiment of the present inventive concept, the third main insulating surface 30 is a surface corresponding to the remaining portion of the inside surface of the slot 5 and is connected to the other end of the first main insulating surface 10 and encloses the third coil C3.

The third main insulating surface 30 insulates between the second corresponding surface 8b of the third coil C3 and the stator core 3. Further, the third main insulating surface 30 may be connected to the other end of the first main insulating surface 10 through a second connection surface 31. In this case, the second connection surface 31 may insulate between the first corresponding surface 8a, which corresponds to a width direction of the slot 5, of the third coil C3 and the stator core 3.

According to the exemplary embodiment of the present inventive concept, the first sub insulating surface 50 insulates between the first and second coils C1 and C2 which are enclosed with the second main insulating surface 20. The first sub insulating surface 50 is connected to the second main insulating surface 20, enclosing the second coil C2 adjacent to the third coil C3, and interposed between the second coil C2 and the first coil C1 adjacent thereto.

Here, the first sub insulating surface 50 encloses the second coil C2 and may insulate the first corresponding surface 8a between the first and second coils C1 and C2. That is, the first sub insulating surface 50 may enclose the second coil C2 between the first main insulating surface 10 and the second main insulating surface 20 and may be interposed into the first coil C1.

The first sub insulating surface 50 includes a first surface 51 which insulates the first corresponding surface 8a of the second coil C2. A second surface 52 is connected to the first surface 51 and is interposed between the first main insulating surface 10 and the second corresponding surface 8b of the second coil C2. A third surface 53 is connected to the second surface 52 and interposed between the first corresponding surfaces 8a of the first and second coils C1 and C2. In this case, the second surface 52 of the first sub insulating surface 50 and the first main insulating surface 10 may overlap each other.

According to the exemplary embodiment of the present inventive concept, the second sub insulating surface 70 insulates the first corresponding surface 8a of the third coil C3 between the second and third coils C2 and C3 and is connected to the third main insulating surface 30 and is interposed between the second and third coils C2 and C3.

That is, the second sub insulating surface 70 may be interposed between the second and third coils C2 and C3 between the first main insulating surface 10 and the third main insulating surface 30. The second sub insulating surface 70 includes a fourth surface 74 insulating the first corresponding surface 8a of the third coil C3 between the second and third coils C2 and C3.

Here, as described above, the first surface 51 of the first sub insulating surface 50 and a fourth surface 74 of the second sub insulating surface 70 may overlap each other between the second and third coils C2 and C3.

According to the exemplary embodiment of the present inventive concept, the third main insulating surface 30 insulates the second corresponding surface 8b of the third coil C3 and the first surface 51 of the first sub insulating surface 50 insulates the second and third coils C2 and C3, and therefore, the fourth surface 74 of the second sub insulating surface 70 may also be removed.

However, when the second corresponding surface 8b of the third coil C3 is covered with the third main insulating surface 30, it may be difficult to accurately implement the insulating paper 90, and thus, according to the exemplary embodiment of the present inventive concept, the fourth surface 74 of the second sub insulating surface 70 may be interposed between the second and third coils C2 and C3.

Further, according to the exemplary embodiment of the present inventive concept, the first surface 51 of the first sub insulating surface 50 and the fourth surface 74 of the second sub insulating surface 70 overlap each other between the second and third coils C2 and C3 to be able to insulate between the second and third coils C2 and C3 and improve the assembling performance of the insulating paper 90.

Therefore, according to the insulating unit 100 for a driving motor according to the exemplary embodiment of the present inventive concept configured as described above, a sheet of insulating paper 90 made of a flexibly changeable material as an electric insulating material is folded to configure the first, second, and third main insulating surfaces 10, 20, and 30 and the first and second sub insulating surfaces 50 and 70 for insulating the three coils C1, C2, and C3.

According to the exemplary embodiment of the present inventive concept, the insulating paper 90 is mounted in each slot 5 of the stator core 3, in which one slot 5 may be provided with one sheet or two sheets of insulating papers 90. However, an example in which one slot 5 is provided with two sheets of insulating papers 90 and the slot 5 is inserted with six coils will be described below.

As such, according to the exemplary embodiment of the present inventive concept, in the state in which each of the slots 5 of the stator core 3 is mounted with the two sheets of insulating papers 90, the three coils C1, C2, and C3 are inserted into each of the insulating papers 90.

According to the exemplary embodiment of the present inventive concept, the first coil C1 is inserted between the third surface 53 of the first sub insulating surface 50 and the first connection surface 21 within the first main insulating surface 10 and the second main insulating surface 20. The second coil C2 is inserted between the first surface 51 and the third surface 53 of the first sub insulating surface 50. The third coil C3 is inserted between the fourth surface 74 of the second sub insulating surface 70 and the second connection surface 31 within the first main insulating surface 10 and the third main insulating surface 30.

By the configuration, according to the exemplary embodiment of the present inventive concept, it is possible to ensure insulating between the first, second, and third coils C1, C2, and C3 inserted into the slots 5 of the stator core 3 and between the coils C1, C2, and C3 and the stator core 3 by the first, second, and third main insulating surfaces 10, 20, and 30 and the first and second sub insulating surfaces 50 and 70 of the insulating paper 90.

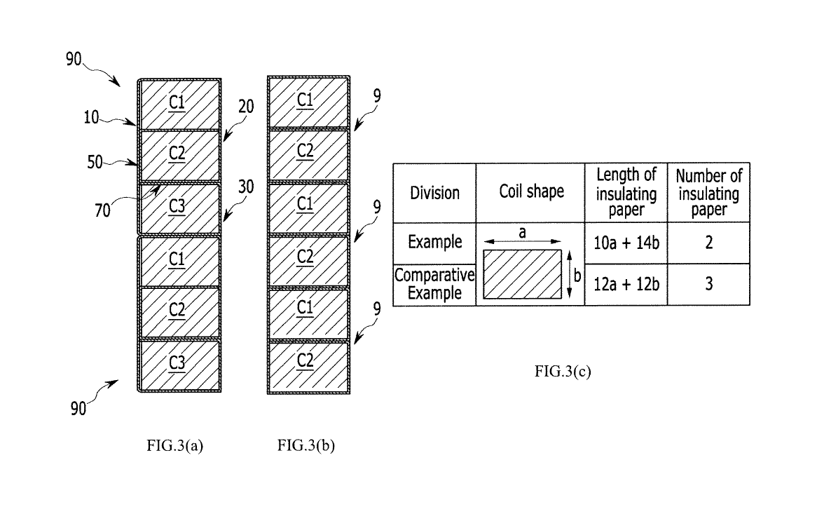

FIGS. 3(a) to 3(c) are diagrams for describing an action effect of the insulating unit for a driving motor according to the exemplary embodiment of the present inventive concept.

Referring to FIG. 3(a), according to the exemplary embodiment of the present inventive concept, two sheets of insulating papers 90 including the first, second, and third main insulating surfaces 10, 20, and 30 and the first and second sub insulating surfaces 50 and 70 are inserted into the slots 5 of the stator core 3 (refer to FIG. 1) and the three first, second, and third coils C1, C2, and C3 are inserted into each of the insulating sheets 90.

FIG. 3(b) shows Comparative Example in which three sheets of insulating papers 9 having a “B” shape are inserted into the slots 5 of the stator core 3, and the two coils C1 and C2 are inserted into each of the insulating papers 9.

As illustrated in FIG. 3(c), when a length of a surface corresponding to the width direction of the slots 5 of each of the coils C1, C2, and C3 is “a” and a length of a surface corresponding to a length direction of the slot 5 is “b”, “a” is greater than “b” according to the coils C1, C2, and C3 of the typical segment coil stator.

Based on a coil shape, a total length of two sheets of insulating papers 90 is 10a+14b and in Example, and a total length of three sheets of insulating papers 9 is 12a+12b in Comparative Example. Therefore, it may be appreciated that the total length of the insulating papers 90 according to Example of the present disclosure is shorter by −2a+2b than that of the insulating papers 9 according to Comparative Example.

As a result, when the same number of coils is inserted into the slots having the same size, the total consumption and the manufacturing cost of the insulating papers 90 may be less than those of Comparative Example.

Further, when the same number of coils is inserted into the slots, the number of used insulating papers 90 may be reduced as compared to Comparative Example, and therefore, the assembling man hour of the stator coil may be reduced and the workability and productivity of the stator coil winding may be improved.

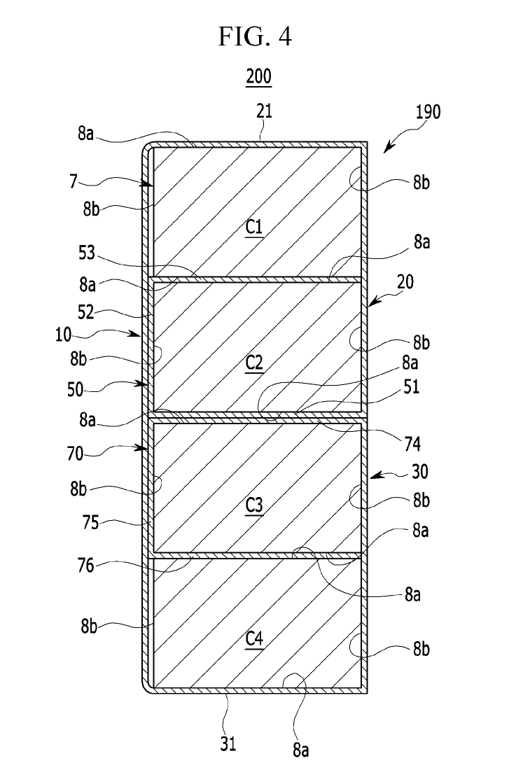

FIG. 4 is a cross-sectional configuration diagram of an insulating unit for a driving motor according to another exemplary embodiment of the present inventive concept. In the drawing, the same components as the exemplary embodiment are denoted by the same reference numerals.

Referring to FIG. 4, the insulating unit 200 for a driving motor according to another exemplary embodiment of the present inventive concept is based on the structure of the foregoing exemplary embodiment. A sheet of insulating paper 190 is mounted in the slot 5 (hereinafter, see FIG. 1) of the stator core 3 (see FIG. 1) to insulate between the coils 7 and between the coils 7 and the stator core 3.

To this end, the insulating unit 200 for a driving motor according to another exemplary embodiment of the present inventive concept includes a first main insulating surface 10, a second main insulating surface 20, a third main insulating surface 30, a first sub insulating surface 50, and a second sub insulating surface 70.

Hereinafter, the coils 7 are defined by a first coil C1, a second coil C2, a third coil C3, and a fourth coil C4 from the top to the bottom in FIG. 4.

The first main insulating surface 10 corresponds to one inside surface of the slot 5 in a length direction and insulates between the second corresponding surface 8b which corresponds to the length direction of the slots 5 of the coils C1, C2, C3, and C4 and the stator core 3.

The second main insulating surface 20 corresponds to a portion of the inside surface of the slot 5, is connected to one end of the first main insulating surface 10, and encloses the first and second coils C1 and C2.

The second main insulating surface 20 insulates between the second corresponding surface 8b of the first and second coils C1 and C2 and the stator core 3. The second main insulating surface 20 may be connected to one end of the first main insulating surface 10 through a first connection surface 21. In this case, the first connection surface 21 may insulate between the first corresponding surface 8a which corresponds to a width direction of the slot 5 of the first coil C1 and the stator core 3.

The third main insulating surface 30 corresponds to the remaining portion of the inside surface of the slot 5, is connected to the other end of the first main insulating surface 10, and encloses the remaining two third and fourth coils C3 and C4.

The third main insulating surface 30 insulates between the second corresponding surface 8b of the third and fourth coils C3 and C4 and the stator core 3. Further, the third main insulating surface 30 may be connected to the other end of the first main insulating surface 10 through a second connection surface 31. In this case, the second connection surface 31 may insulate between the first corresponding surface 8a which corresponds to the width direction of the slot 5 of the fourth coil C4 and the stator core 3.

The first sub insulating surface 50 insulates between the first and second coils C1 and C2 which are enclosed with the second main insulating surface 20, is connected to the second main insulating surface 20, encloses the second coil C2 adjacent to the third coil C3, and is interposed between the second coil C2 and the first coil C1 adjacent thereto.

The first sub insulating surface 50 encloses the second coil C2 and may insulate the first corresponding surface 8a between the first and second coils C1 and C2. That is, the first sub insulating surface 50 may enclose the second coil C2 between the first main insulating surface 10 and the second main insulating surface 20 and may be disposed onto the first coil C1.

The first sub insulating surface 50 includes a first surface 51 which insulates the first corresponding surface 8a of the second coil C2. A second surface 52 is connected to the first surface 51 and interposed between the first main insulating surface 10 and the second corresponding surface 8b of the second coil C2. A third surface 53 is connected to the second surface 52 and is interposed between the first corresponding surfaces 8a of the first and second coils C1 and C2.

In this case, the second surface 52 of the first sub insulating surface 50 and the first main insulating surface 10 may overlap each other.

The second sub insulating surface 70 insulates the first corresponding surfaces 8a of the third and fourth coils C3 and C4 adjacent to the first and second coils C1 and C2, is connected to the third main insulating surface 30, and is interposed between the third and fourth coils C3 and C4. That is, the second sub insulating surface 70 may enclose the third coil C3 between the first main insulating surface 10 and the third main insulating surface 30, and may be interposed between the third coil C3 and the fourth coil C4 adjacent thereto.

The second sub insulating surface 70 includes a fourth surface 74 which insulates the first corresponding surface 8a of the third coil C3 between the second and third coils C2 and C3. A fifth surface 75 is connected to the fourth surface 74 and interposed between the first main insulating surface 10 and the second corresponding surface 8b of the third coil C3. A sixth surface 76 is connected to the fifth surface 75 and disposed on the first corresponding surfaces 8a of the third coil C3 and the fourth coil C4.

As described above, the first surface 51 of the first sub insulating surface 50 and the fourth surface 74 of the second sub insulating surface 70 may overlap each other between the second and third coils C2 and C3. Further, the fifth surface 75 of the second sub insulating surface 70 and the first main insulating surface 10 may overlap each other.

Therefore, according to the insulating unit 200 for a driving motor according to another exemplary embodiment of the present inventive concept, the sheet of insulating paper 190 made of a flexibly changeable material as an electric insulating material is folded to configure the first, second, and third main insulating surfaces 10, 20, and 30 and the first and second sub insulating surfaces 50 and 70 for insulating the four coils C1, C2, C3, and C4.

According to the exemplary embodiment of the present inventive concept, the four coils C1, C2, C3, and C4 are inserted into the insulating paper 190 in the state in which the insulating paper 190 is mounted in each slot 5 of the stator core 3.

Here, according to the exemplary embodiment of the present inventive concept, the first coil C1 is inserted between the third surface 53 of the first sub insulating surface 50 and the first connection surface 21 between the first main insulating surface 10 and the second main insulating surface 20. The second coil C2 is inserted between the first surface 51 and the third surface 53 of the first sub insulating surface 50. The third coil C3 is inserted between the fourth surface 74 and the sixth surface 76 of the second sub insulating surface 70 between the first main insulating surface 10 and the third main insulating surface 30. The fourth coil C4 is inserted between the sixth surface 76 and the second connection surface 31.

By the configuration, according to the exemplary embodiment of the present inventive concept, it is possible to ensure insulating between the first, second, third, and fourth coils C1, C2, C3, and C4 inserted into the slots 5 of the stator core 3 and between the coils C1, C2, C3, and C4 and the stator core 3 by the first, second, and third main insulating surfaces 10, 20, and 30 and the first and second sub insulating surfaces 50 and 70 of the insulating paper 190.

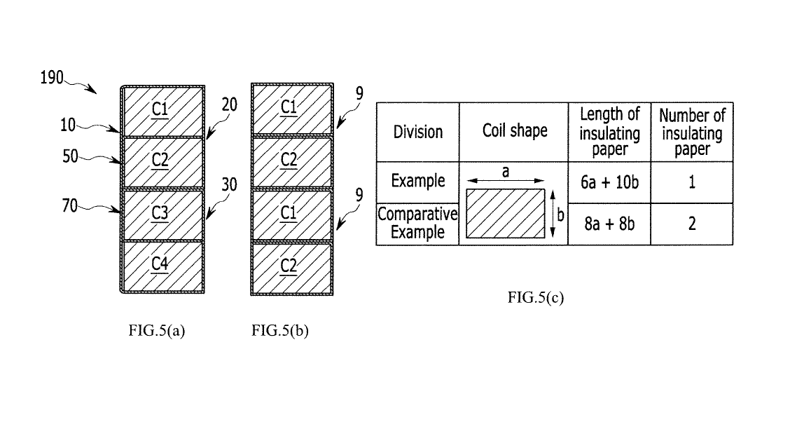

FIGS. 5(a) to 5(c) are diagrams for describing an action effect of the insulating unit for a driving motor according to another exemplary embodiment of the present inventive concept.

Referring to FIG. 5(a), in Example according to another exemplary embodiment of the present inventive concept, one sheet of insulating paper 190 including the first, second, and third main insulating surfaces 10, 20, and 30 and the first and second sub insulating surfaces 50 and 70 is inserted into each slot 5 of the stator core 3 (refer to FIG. 1) and the four first, second, third, and fourth coils C1, C2, C3, and C4 are inserted into the insulating sheet 190.

In Comparative Example as illustrated in FIG. 5(b), two sheets of insulating papers 9 having a “B” shape are inserted into the slots 5 of the stator core 3, and the two coils C1 and C2 are inserted into each of the insulating papers 9.

Referring to FIG. 5(c), when a length of a surface corresponding to a width direction of the slots 5 of each of the coils C1, C2, C3, and C4 is “a” and a length of a surface corresponding to a length direction of the slots 5 is “b”, “a” is greater than “b” according to the coils C1, C2, C3, and C4 of the typical segment coil stator.

Based on a coil shape, a total length of one sheet of insulating papers 190 is 6a+10b in Example, and in a total length of two sheets of insulating papers 9 is 8a+8b Comparative Example. Therefore, it may be appreciated that the length of the insulating paper 190 according to Example is shorter by −2a+2b than the total length of the two sheets of insulating papers 9 according to Comparative Example.

As a result when the same number of coils is inserted into the slots having the same size, the total consumption and the manufacturing cost of the insulating paper 190 may be more reduced than those of Comparative Example.

Further, in Example of the present disclosure, when the same number of coils is inserted into the slots, the number of used insulating papers 190 may be reduced, and therefore, the assembling man hour of the stator coil may be reduced and the workability and productivity of the stator coil winding may be improved.

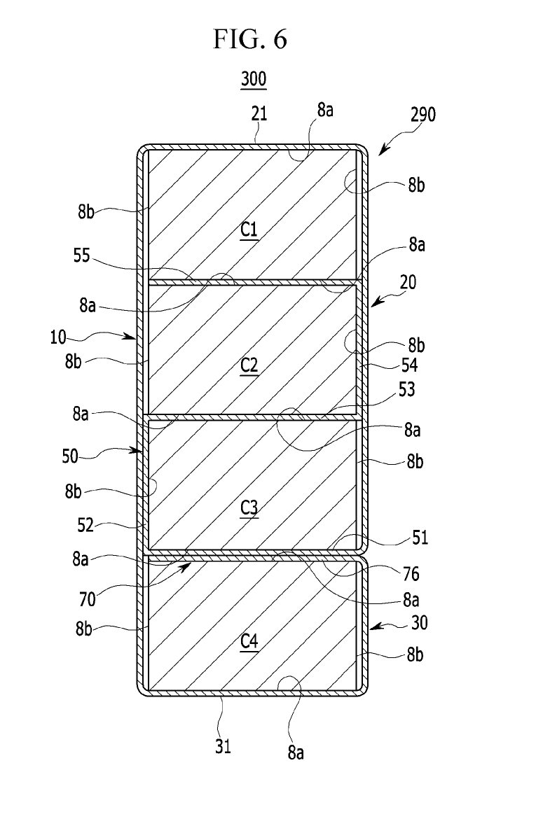

FIG. 6 is a cross-sectional configuration diagram of the insulating unit for a driving motor according to another exemplary embodiment of the present inventive concept. In the drawing, the same components as the foregoing exemplary embodiment are denoted by the same reference numerals.

Referring to FIG. 6, an insulating unit 300 for a driving motor according to yet another exemplary embodiment of the present inventive concept includes a sheet of insulating paper 290 to insulate between four coils 7 and between the coils 7 and the stator core 3 and to insulate three among four coils 7 as one group and insulate between the three coils and the remaining one coil.

The insulating unit 300 for a driving motor according to yet another exemplary embodiment of the present inventive concept includes a first main insulating surface 10, a second main insulating surface 20, a third main insulating surface 30, a first sub insulating surface 50, and a second sub insulating surface 70.

Hereinafter, the four coils 7 are defined by first coil C1, second coil C2, third coil C3, and fourth coil C4 based on a direction from the top to the bottom in FIG. 6.

The first main insulating surface 10 is a surface corresponding to one inside surface of the slot 5 (refer to FIG. 1) in a length direction and insulates between the second corresponding surface 8b which corresponds to the length of the slots 5 of the first, second, third, and four coils C1, C2, C3, and C4 and the stator core 3.

The second main insulating surface 20 corresponds to a portion of the inside surface of the slot 5, is connected to one end of the first main insulating surface 10, and encloses the three first, second, and third coils C1, C2, and C3.

The second main insulating surface 20 insulates between the second corresponding surfaces 8b of the first, second, and third coils C1, C2, and C3 and the stator core 3 (refer to FIG. 1). The second main insulating surface 20 may be connected to one end of the first main insulating surface 10 through a first connection surface 21. In this case, the first connection surface 21 may insulate between the first corresponding surface 8a which corresponds to a width direction of the slots 5 of the first coil 7 and the stator core 3.

The third main insulating surface 30 corresponds to the remaining portion of the inside surface of the slot 5, is connected to the other end of the first main insulating surface 10, and encloses the fourth coil C4.

The third main insulating surface 30 insulates between the second corresponding surface 8b of the fourth coil C4 and the stator core 3. Further, the third main insulating surface 30 may be connected to the other end of the first main insulating surface 10 through a second connection surface 31. In this case, the second connection surface 31 may insulate between the first corresponding surface 8a which corresponds to the width direction of the slots 5 of the fourth coil C4 and the stator core 3.

The first sub insulating surface 50 insulates between the first, second, and third coils C1, C2, and C3 which are enclosed with the second main insulating surface 20 and is connected to the second main insulating surface 20. The first sub insulating surface 50 encloses the third coil C3 adjacent to the fourth coil C4 and the second coil C2 adjacent to the third coil C3, and is interposed between the second coil C2 and the first coil C1 adjacent thereto.

Here, the first sub insulating surface 50 encloses the second and third coils C2 and C3 and may insulate the first corresponding surface 8a between the first, second, and third coils C1, C2, and C3. That is, the first sub insulating surface 50 may enclose the second and third coils C2 and C3 between the first main insulating surface 10 and the second main insulating surface 20 and may be interposed into the first coil C1.

The first sub insulating surface 50 includes a first surface 51 which insulates the first corresponding surface 8a of the third coil C3. A second surface 52 is connected to the first surface 51 and interposed between the first main insulating surface 10 and the second corresponding surface 8b of the third coil C3. A third surface 53 is connected to the second surface 52 and disposed on the first corresponding surface 8a of the second and third coils C2 and C3. A fourth surface 54 is connected to the third surface 53 and is interposed between the second main insulating surface 20 and the second corresponding surface 8b of the second coil C2. The fifth surface 55 is connected to the fourth surface 54 and is disposed on the first corresponding surface 8a of the first and second coils C1 and C2.

In this case, the second surface 52 of the first sub insulating surface 50 and the first main insulating surface 10 overlap each other, and the fourth surface 54 and the second main insulating surface 20 also overlap each other.

The second sub insulating surface 70 insulates the first corresponding surface 8a of the fourth coil C4 between the third and fourth coils C3 and C4, is connected to the third main insulating surface 30, and is interposed between the third and fourth coils C3 and C4. That is, the second sub insulating surface 70 may be interposed between the third and fourth coils C3 and C4 within the first main insulating surface 10 and the third main insulating surface 30. The second sub insulating surface 70 includes a sixth surface 76 insulating the first corresponding surface 8a of the fourth coil C4 between the third and fourth coils C3 and C4.

As described above, the first surface 51 of the first sub insulating surface 50 and the sixth surface 76 of the second sub insulating surface 70 may overlap each other between the third and fourth coils C3 and C4.

According to the exemplary embodiment of the present inventive concept, the third main insulating surface 30 insulates the second corresponding surface 8b of the fourth coil C4 and the first surface 51 of the first sub insulating surface 50 insulates the second and third coils C3 and C4, and therefore, the sixth surface 76 of the second sub insulating surface 70 may also be removed.

When the second corresponding surface 8b of the fourth coil C4 is covered with the third main insulating surface 30, however, it may be difficult to accurately implement the insulating paper 290 and thus, according to the exemplary embodiment of the present inventive concept, the sixth surface 76 of the second sub insulating surface 70 may be interposed between the third and fourth coils C3 and C4.

Further, according to the exemplary embodiment of the present inventive concept, the first surface 51 of the first sub insulating surface 50 and the sixth surface 76 of the second sub insulating surface 70 overlap each other between the third and fourth coils C3 and C4 to insulate between the third and fourth coils C3 and C4 and improve the assembling performance of the insulating paper 290.

Therefore, according to the insulating unit 300 for a driving motor according to another exemplary embodiment of the present inventive concept as described above, the insulating paper 290 made of a flexibly changeable material as an insulating material is folded to configure the first, second, and third main insulating surfaces 10, 20, and 30 and the first and second sub insulating surfaces 50 and 70 for insulating the four coils C1, C2, C3, and C4.

According to the exemplary embodiment of the present inventive concept, the four coils C1, C2, C3, and C4 are inserted into the insulating paper 290 in the state in which the insulating paper 290 is mounted in each slot 5 of the stator core 3.

According to the exemplary embodiment of the present inventive concept, the first coil C1 is inserted between the fifth surface 55 of the first sub insulating surface 50 and the first connection surface 21 between the first main insulating surface 10 and the second main insulating surface 20. The second coil C2 is inserted between the third surface 53 and the fifth surface 55 of the first sub insulating surface 50. The third coil C3 is inserted between the first surface 51 and the third surface 53 of the first sub insulating surface 50. The fourth coil C4 is inserted between the sixth surface 76 of the second sub insulating surface 70 and the second connection surface 31 between the first main insulating surface 10 and the third main insulating surface 30.

By the configuration, according to the exemplary embodiment of the present inventive concept, it is possible to ensure insulating between the first, second, third, and fourth coils C1, C2, C3, and C4 inserted into the slots 5 of the stator core 3 and between the coils C1, C2, C3, and C4 and the stator core 3 by the first, second, and third main insulating surfaces 10, 20, and 30 and the first and second sub insulating surfaces 50 and 70 of the insulating paper 290.

The action effects of the insulating unit 300 for a driving motor according to another exemplary embodiment of the present inventive concept are the same the foregoing exemplary embodiments and therefore the detailed description thereof will be omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An insulating unit for a driving motor which insulates between at least three coils inserted into slots of a stator and between the coils and a stator core, the insulating unit comprising:
a first main insulating surface corresponding to one inside surface of a slot in a length direction of the slot;
a second main insulating surface connected to one end of the first main insulating surface, the second main insulating surface enclosing two coils among the at least three coils and corresponding to a portion of another inside of the slot;
a third main insulating surface connected to another end of the first main insulating surface, the third main insulating surface enclosing at least one of remaining coils and corresponding to the remaining portion of the other inside of the slot; and
a first sub insulating surface connected to the second main insulating surface, the first sub insulating surface enclosing one of the two coils which is adjacent to the at least one of remaining coils.

2. The insulating unit of claim 1, wherein a sheet of insulating paper mounted in the slot insulates between the at least three coils and between the coils and the stator core.

3. The insulating unit of claim 1, wherein two sheets of insulating papers mounted in the slot insulates between the at least three coils and between the coils and the stator core.

4. The insulating unit of claim 1, wherein the first sub insulating surface encloses one of the two coils between the first main insulating surface and the second main insulating surface.

5. The insulating unit of claim 1, further comprising:
a second sub insulating surface connected to the third main insulating surface and disposed between the two coils and the at least one of remaining coils adjacent to the two coils.

6. The insulating unit of claim 5, wherein the second sub insulating surface is disposed between the first main insulating surface and the third main insulating surface.

7. The insulating unit of claim 5, wherein the second sub insulating surface encloses the at least one of remaining coils adjacent to the two coils between the first main insulating surface and the third main insulating surface, and is disposed between the enclosed coil and the one of the two coils which is adjacent to the enclosed coil.

8. The insulating unit of claim 5, wherein the first and second sub insulating surfaces overlap each other between the two coils and the at least one of remaining coils adjacent to the two coils.

9. The insulating unit of claim 5, wherein the first main insulating surface and at least any one of the first and second sub insulating surfaces overlap each other.

10. The insulating unit of claim 2, wherein the insulating paper insulates between the coils having a quadrangular section and between the coils and the stator core.

11. The insulating unit of claim 3, wherein the insulating papers insulate between the coils having a quadrangular section and between the coils and the stator core.

12. The insulating unit of claim 5, wherein
at least one insulating paper mounted in the slot insulates between the coils and between the coils and the stator core, and
the insulating paper insulates between the coils for a>b and between the coils and the stator core, where a length of a surface corresponding to a width direction of the slot of the coil is “a,” and a length of a surface corresponding to a length direction of the slot is “b.”

13. The insulating unit of claim 12, wherein
the first, second, and third main insulating surfaces insulate between the surface corresponding to the length direction of the slot and the stator core, and
the first and second sub insulating surfaces insulate the surface corresponding to the width direction of the slot between the coils.

14. The insulating unit of claim 13, wherein the first sub insulating surface includes:
a first surface insulating a surface corresponding to a width direction of the one of the two coils adjacent to the at least one of remaining coils;
a second surface connected to the first surface and disposed between the first main insulating surface and a surface corresponding to a length direction of the one of the two coils; and
a third surface connected to the second surface and disposed onto a surface corresponding to the width direction of the two coils.

15. The insulating unit of claim 14, wherein the second sub insulating surface includes a fourth surface insulating a surface corresponding to the width direction of the at least one of remaining coils adjacent to the two coils.

16. The insulating unit of claim 14, wherein the second sub insulating surface includes:
a fourth surface insulating a surface corresponding to the width direction of the at least one of remaining coils adjacent to the two coils;
a fifth surface connected to the fourth surface and disposed between the first main insulating surface and a surface corresponding to a length direction of the at least one of remaining coils; and
a sixth surface connected to the fifth surface and disposed between the at least one of remaining coils and a surface corresponding to a width direction of another remaining coil.

17. An insulating unit for a driving motor which has three coils inserted into slots of a stator as at least one group and insulates between the coils and a stator core, the insulating unit comprising:
a first main insulating surface corresponding to one inside surface of a slot in a length direction of the slot;
a second main insulating surface connected to one end of the first main insulating surface, the second main insulating surface enclosing two coils among the three coils and corresponding to a portion of another inside of the slot;
a third main insulating surface connected to the other end of the first main insulating surface, the third main insulating surface enclosing the remaining coil and corresponding to the remaining portion of the other inside of the slot; and
a first sub insulating surface connected to the second main insulating surface, the first sub insulating surface enclosing one of the two coils which is adjacent to the remaining coil.

18. The insulating unit of claim 17, further comprising:
a second sub insulating surface connected to the third main insulating surface and disposed between the two coils and the remaining coil adjacent to the two coils between the first main insulating surface and the third main insulating surface.

19. The insulating unit of claim 18, wherein
the first and second sub insulating surfaces are disposed to overlap each other between the two coils and the remaining coil adjacent to the two coils, and
the first main insulating surface and the first sub insulating surface are disposed to overlap each other.

20. An insulating unit for a driving motor which insulates between four coils inserted into slots of a stator and between the coils and a stator core, the insulating unit comprising:
a first main insulating surface corresponding to one inside surface of a slot in a length direction of the slot;
a second main insulating surface connected to one end of the first main insulating surface, the second main insulating surface enclosing two coils among the four coils and corresponding to a portion of another inside of the slot;
a third main insulating surface connected to the other end of the first main insulating surface, the third main insulating surface enclosing the other two remaining coils and corresponding to the remaining portion of the other inside of the slot;
a first sub insulating surface connected to the second main insulating surface, the first sub insulating surface enclosing one coil of the two coils and disposed between the enclosed coil and the other coil among the two coils which is adjacent to the enclosed coil; and
a second sub insulating surface connected to the third main insulating surface, the second sub insulating surface enclosing one of the other two remaining coils which is adjacent to the two coils between the first main insulating surface and the third main insulating surface.

21. The insulating unit of claim 20, wherein
the first and second sub insulating surfaces are disposed to overlap each other between the two coils and the one of the other two remaining coils which is adjacent to the two coils, and
the first main insulating surface and the first and second sub insulating surfaces are disposed to overlap each other.

22. An insulating unit for a driving motor which insulates between four coils inserted into slots of a stator and between the coils and a stator core, the insulating unit comprising:
a first main insulating surface corresponding to one inside surface of a slot in a length direction of the slot;
a second main insulating surface connected to one end of the first main insulating surface, the second main insulating surface enclosing three coils among the four coils and corresponding to a portion of another inside of the slot;
a third main insulating surface connected to the other end of the first main insulating surface, the second main insulating surface enclosing the remaining coil and corresponding to the remaining portion of the other inside of the slot; and
a first sub insulating surface connected to the second main insulating surface, the first sub insulating surface and the second main insulating surface enclosing two coils among the three coils adjacent to the remaining coil.

23. The insulating unit of claim 22, further comprising:
a second sub insulating surface connected to the third main insulating surface and disposed between the three coils and the remaining coil adjacent to the three coils, between the first main insulating surface and the third main insulating surface.

24. The insulating unit of claim 23, wherein
the first and second sub insulating surfaces overlap each other between the three coils and the remaining coil adjacent to the three coils, and
the first and second main insulating surfaces and the first sub insulating surface overlap each other.
